(19) United States
(12) Patent Application Publication
(10) Pub. No.: US 2011/0077316 A1
(43) Pub. Date: Mar. 31, 2011

(54) Biosealant Protective Barrier for Surfaces

(76) Inventor: William Davis COLLINS, Fayetteville, AR (US)

(21) Appl. No.: 12/569,937

(22) Filed: Sep. 30, 2009

(51) Int. Cl. C09D 5/00

(52) U.S. Cl. 521/155; 524/589; 528/44

(57) ABSTRACT

A protective barrier sealant product and methods of applying the same, including a high density polyurethane material provided in an amount, volume, and density effective for providing a protective barrier for a surface, wherein the polyurethane material is combined with at least one active agent just prior to or at the time of application of the sealant product to an object surface.

### BACKGROUND OF THE INVENTION

1. Field of the Invention

The present invention relates generally to protective barrier products. Furthermore, the present invention relates to protective barrier products for application to hard surfaces, and to systems and methods relating thereto.

2. Description of the Prior Art

It is generally known in the art to provide for cleaning and treatment of surfaces to protect against contamination, deterioration, stains, water infiltration, rust, corrosion and insect-based damage. More particularly, it is known to provide protection onto hard surfaces, including metal, glass, wood, plastics, cinder blocks, glass board, polyurethane foams and sprays that act as an adhesive or sealant such as caulk. The invention also acts as a partial barrier against one or more of microbes, mold, mildew, gas deterioration, moisture deterioration, fungi, insect damage, and/or corrosion. It is known that such prior art coatings may be applied to metal, glass or wood.

Relevant prior art references include U.S. Pat. Nos. 4,318,959; 4,596,725; 4,795,760; 4,939,184; 5,549,869; 5,583,230; 5,804,641; 5,900,195; 6,402,201; 6,887,966; 7,459,167; and US Patent Application Publication Nos. 20040077747; 20030207122.

None of the prior art references provide for a protective sealant product which includes an insulative material and at least one active agent wherein the sealant has at least one exposed surface.

Thus there remains a need for a barrier product for protecting surfaces against external damaging agents or forces, including but not limited to microbes, mold, mildew, gas deterioration, moisture deterioration, insect damage, and/or corrosion, while also providing some insulating properties for the exposed surface and/or environment enclosed by the surfaces.

### SUMMARY OF THE INVENTION

A first aspect of the present invention is to provide a protective barrier product using polyurethane chemistry and an antimicrobial element provided in an amount, volume, and density effective for providing a protective barrier for most surfaces. More particularly, the barrier product provides a protective barrier for surfaces from microbes, mold, mildew, gas deterioration, moisture deterioration, insect damage, corrosion, and combinations thereof, and further provides insulating properties for the exposed surface and/or environment enclosed by the surfaces.

A second aspect of the present invention is to provide methods for applying to surfaces the product that provides both biosecurity protection and exposed, insulative surface properties.

Yet another aspect of the present invention is a protective barrier and insulative product including exposed polyurethane foam, and methods of applying the same to hard surfaces for providing a biosealant.

These and other aspects of the present invention will become apparent to those skilled in the art after a reading of the following description of the preferred embodiment when considered with the drawings, as they support the claimed invention.

### DETAILED DESCRIPTION

The present invention provides a protective barrier sealant product including a high density polyurethane foam material provided in an amount, volume, and density effective for providing a protective barrier for a surface, wherein the sealant material is combined with at least one active agent just prior to or at the time of application of the sealant product to an object surface. More particularly, the barrier product provides a protective barrier for surfaces from microbes, mold, mildew, gas deterioration, moisture deterioration, insects and damage from corrosion and combinations thereof, and further provides insulating properties for the exposed surface and/or environment enclosed by the surfaces. Furthermore, the present invention provides methods for applying to surfaces the protective barrier product that provides both biosecurity protection and exposed, insulative surface properties.

The protective barrier and insulative product of the present invention is importantly established with an exposed polyurethane foam on a top exposed surface area of a space or of an object, and methods of applying the same to hard surfaces for providing a biosealant effective against microorganisms and/or damage from moisture, air, vapor, or other deterioration by pests or insects, as well as providing a physical barrier to resist damage and/or wear.

The present invention provides a sealant product for protecting surfaces including a foam material having a top exposed surface that is spaced apart from a bottom surface wherein the spaced apart distance provides for an insulative thickness of the foam material, forming a coating on at least one object surface. Preferably, the sealant product is a dual component formulation, wherein the sealant components are combined or mixed prior to or at the time of application of the sealant to the object surface.

The at least one active ingredient provides antimicrobial, antifungal or antibacterial protection and combinations thereof. Preferably, the combination of the at least one active agent with the sealant material ensures that no living organism grows on or within the sealant product, including but not limited to the prevention of mold, mildew, bacteria, fungi, or other microorganisms.

In methods of using the sealant product according to the present invention, method steps include providing a sealant product including a polyurethane material and at least one active agent; applying the sealant product onto an object surface; wherein upon application to the surface the polyurethane material expands to produce an insulative thickness between the object surface and the top exposed surface of the sealant product; and wherein the top exposed surface of the sealant product provides barrier protection as a coating for the object surface. Importantly, while the polyurethane material may provide some protection for antimicrobial and antifungal applications, as well as providing a physical barrier with the top exposed surface of the sealant product for protecting the object surface, preferred embodiments of the present invention include at least one active agent in the formulation so that the active agent, combined with the polyurethane material, provides controlled and enhanced effective antimicrobial and antifungal protection, based upon the at least one active agent selected. Also, as a dual component formulation, the combination of the at least one active agent with the polyurethane material may be done prior to application of the sealant product to the object surface, or at the time of application (through controlled mixing or combination with an application device that provides for separation of the polyurethane material and the at least one active agent until the time of application).

Application of the sealant product according to the present invention is preferably by spray application to the object surface, and preferably provides for the dual component mixing of the polyurethane material and the at least one active agent on site or location of the object surface to be coated and protected by the sealant product. In this manner, the final formulation of the sealant product composition occurs during the mixing process just prior to or upon application (in the air during spray application) to the object surface. At the time of application to the object surface, the polyurethane material expands to provide a thickness between about ⅛ inch (3.175 mm) and about ½ inch (6.350 mm). The expansion of the polyurethane material provides for insulative thickness to provide energy efficient insulation when applied to building or room surfaces, including floors, walls, ceilings, etc. The final mixed and expanded state of the sealant product provides a top exposed surface that is resistant to cracking, breaking, chipping, corrosion, or other deterioration, and provides a physical barrier of protection to the coated object surface. Also, this barrier can act to reduce the impact upon the surface and increase its resistance to damage. Furthermore, the sealant product adheres to the object surface, so it resists delamination or peeling as well. The sealant product is applicable to any object surface, including but not limited to object surfaces selected from metal, glass, wood, plastic, concrete, cinder block, asphalt, glass board, polyurethane foams other sealant type material such as caulks and the like, and combinations thereof.

Referring now to testing results In general, these test results are illustrations for the purpose of describing a preferred embodiment of the invention and are not intended to limit the invention thereto. In these test cases, laboratory application of the sealant product according to the present invention under ASTM standards applicable for antimicrobial testing for fungal and bacterial resistance. In one embodiment of the present invention, the sealant product was formulated with a polyurethane material and at least one active agent, wherein the active agent includes at least an antimicrobial agent; the sealant product was applied to an exposed surface of glass microscope slides; at least two samples for each test were provided. After drying, the test samples were placed with the sample side up on Nutrient Salts Agar (NSA) in plates and challenged with a mixed spore suspension of Penicillium funuiculosum, Chaetomium globosum, Aspergillus niger, Aureobasidium pullulans and Gliocladium virens adjusted to one million spores per milliliter. Inoculated samples were incubated at 28 degrees C. for 4 weeks and rated weekly for growth. Absence of growth was confirmed using a low power microscope.

The polyurethane material used for the testing indicated in the following results was selected as a standard 1005 solids polyurethane elastomer. Testing background and experimental protocols included the following: Standard Practice for Determining Resistance of Synthetic Polymeric Materials to Fungi using ASTM G 21-96 (2002); and Bacterial resistance was determined using a standard Zone of Inhibition test for Gram negative and Gram positive organisms. Use-levels ranged from 250 ppm to 1000 ppm were tested. Standard ASTM G 21 fungal resistance test and a standard bacterial resistance tests were used to demonstrate the performance of the sealant product according to one embodiment of the present invention. Conclusions from the testing include: the biosealant product formulation including polyurethane component and at least one antimicrobial agent as an active agent showed efficacy at all use levels against fungi and bacteria under the test conditions. The negative control supported fungal growth and showed no activity against bacteria. Treated samples were resistant to fungal growth and produced zones of inhibition against bacteria at all levels tested. Thus, the biosealant product of the present invention provided effective antimicrobial and antifungal properties for the top exposed surface, thereby providing an effective barrier protectant for the underlying surface of the object or area. Based on these test results data, it is clear that use-levels as low as 250 ppm (0.025% active ingredient) of the antimicrobial agent in the sealant product is an appropriate use-level to provide both fungal and bacterial protection by the biosealant product exposed surface when it is applied as a coating on the object surface. Notably, while this underlying surface was glass, the biosealant protectant is applicable as a coating to objects and other hard surfaces, including floors, walls, ceilings, for treating those surfaces with antimicrobial and antifungal agents within the exposed insulative barrier sealant according to the present invention.

Test results are indicated in Table 1 for antifungal properties and in Table 2 and Table 3 for antimicrobial/antibacterial testing.

TABLE 1
Fungal Resistance Testing (ASTM G 21 Rating)

| Sample | Use-Level | Week 1 | Week 2 | Week 3 | Week 4 |
|---|---|---|---|---|---|
| Negative | 0 | 0, 0 | 1, 1 | 1, 2 | 2, 3 |
| Control | | | | | |
| | 250 ppm | 0, 0 | 0, 0 | 0, 0 | 0, 0 |
| | 500 ppm | 0, 0 | 0, 0 | 0, 0 | 0, 0 |
| | 750 ppm | 0, 0 | 0, 0 | 0, 0 | 0, 0 |
| | 1000 ppm | 0, 0 | 0, 0 | 0, 0 | 0, 0 |

Rating Scale
0 = No growth
1 = Trace growth (<10% coverage)
2 = Light growth (10 to 30% coverage)
3 = Medium growth (30 to 60% coverage)
4 = Heavy growth (60 to 100% coverage)

Regarding bacterial testing, an overnight Tryptic Soy Agar (TSA) slant was prepared for each bacterium. Ten (10) milliliters of sterile water were added to each tube. The bacteria were loosened from the slant surface with a loop, 1.0 mL of this suspension was added to nine (9) mL sterile water, 1.0 mL of this dilution was spread onto the surface of a Nunc plate (245 mm×245 mm×20 mm) containing 100 mL of NA (nutrient agar). Samples (0.75 inches×0.75 inches) were then placed on the plates. The plates were incubated overnight at 35 degrees C. Measurements were made of the zones, if any.

TABLE 2
Bacterial Zone of Inhibition Testing (E. coli & Salmonella)

| | | Gram-Negative | |
|---|---|---|---|
| | | Escherichia coli | Salmonella choleraesuis |
| Sample | Use-Level | ATCC 11229 | ATCC 10708 |
| Negative | 0 | NZ, NZ | NZ, NZ |
| Control | 250 ppm | 5.5, 5.5 | 6.0, 6.0 |
| | 500 ppm | 6.5, 6.5 | 7.0, 6.5 |
| | 750 ppm | 7.0, 7.0 | 7.5, 7.5 |
| | 1000 ppm | 7.0, 7.0 | 7.0, 8.0 |

Note:
all measurements are in millimeters
NZ = No zone
PZ = Partial zone

TABLE 3
Bacterial Zone of Inhibition Testing (Bacillus subtilis &
Staphylococcus aureus)

| | | Gram-Negative | |
|---|---|---|---|
| | | | Staphylococcus aureus |
| | | Bacillus subtilis | Methicillin-resistant |
| Sample | Use-Level | ATCC 6984 | ATCC 33591 |
| Negative | 0 | NZ, NZ | NZ, NZ |
| Control | 250 ppm | 7.0, 7.0 | 5.0, 5.0 |
| | 500 ppm | 8.0, 8.0 | 6.0, 6.5 |
| | 750 ppm | 8.5, 9.0 | 6.5, 7.0 |
| | 1000 ppm | 10.0, 9.0 | 7.5, 7.0 |

Note:
all measurements are in millimeters
NZ = No zone
PZ = Partial zone

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

What is claimed is:

1. A sealant product for protecting surfaces comprising: a polyurethane material having a top exposed surface that is spaced apart from a bottom surface wherein the spaced apart distance provides for an insulative thickness of the polyurethane material for forming a coating on at least one object surface.

2. The sealant product of claim 1, further including at least one active agent combined with the polyurethane material.

3. The sealant product of claim 2, wherein the at least one active agent is mixed with the polyurethane material.

4. The sealant product of claim 2, wherein the at least one active agent includes an antimicrobial agent.

5. The sealant product of claim 2, wherein the at least one active agent includes an antifungal agent.

6. The sealant product of claim 1, wherein the material uses a polyurethane based chemistry.

7. The sealant product of claim 6, wherein the sealant expands after application to the object surface to provide a thickness between ⅛ inch and ½ inch.

8. The sealant product of claim 1, wherein the top exposed surface provides effective antimicrobial and/or antifungal protection by providing a protective barrier for the at least one object surface.

9. The sealant product of claim 1, wherein the top exposed surface provides a physical barrier protecting at least one object surface from damage or exposure to damage from contamination, deterioration, water infiltration, rust, stains, corrosion and insects.

10. A method for providing a protective sealant for surfaces including the steps of:
providing a sealant product further including a polyurethane material;
applying the sealant product onto an object surface; wherein upon application to the surface will expand to produce an insulative thickness between the object surface and the top exposed surface of the sealant product; and wherein the top exposed surface of the sealant product provides barrier protection as a coating for the object surface.

11. The method of claim 10, wherein the sealant product provides barrier protection against physical damage as well as antimicrobial protection.

12. The method of claim 10, wherein at least one active agent is combined with the foam material.

13. The method of claim 12, wherein the at least one active agent is combined with the polyurethane material prior to application of the sealant product to the object surface.

14. The method of claim 12, wherein the at least one active agent is combined with the polyurethane material at the time of application of the sealant product to the object surface.
